(19) United States
(12) Patent Application Publication
(10) Pub. No.: US 2011/0265731 A1
(43) Pub. Date: Nov. 3, 2011

(54) DEVICE FOR STUDYING SLEEP DISTURBANCES IN LABORATORY ANIMALS

(75) Inventor: Maurice Dematteis, Meylan (FR)

(73) Assignee: UNIVERSITE JOSEPH FOURIER, Grenoble Cedex 09 (FR)

(21) Appl. No.: 13/128,730

(22) PCT Filed: Nov. 12, 2009
(86) PCT No.: PCT/FR2009/052175

§ 371 Date: Jul. 19, 2011

(30) Foreign Application Priority Data
Nov. 12, 2008 (FR) 08/06287

(51) Int. Cl. A01K 1/03; A01K 39/04

(52) U.S. Cl. 119/420

(57) ABSTRACT

A device includes, in combination, a horizontal circular support plate (1) for animals (2), driven in rotation about a vertical axis (3), a cylindrical wall (4) the outside diameter of which is substantially equal to that of the rotary plate (1), this wall delimiting an internal confinement space (7) forming a cage for housing the animals moving freely on the plate, a fixed intermediate partition (12), extending inside the cylindrical wall (4) dividing the internal confinement space into two opposite compartments (13, 14), an upper closing lid (15), preferably removable, integral with the intermediate partition (12) and extending parallel to the plate (1), and a system (36) for the supply of a respiratory gas through the closing lid (15) for the animals (2) present in the two opposite compartments (13, 14) of the confinement space (7).

The present invention relates to a device making it possible to experimentally produce determined and measured sleep disturbances in laboratory animals, so as to study the effects of these disturbances and their relationships with any pathologies that they may induce.

The in-depth study of the consequences of sleep disturbances in humans very often makes it necessary to resort to reproducible and controlled experimental models, conducted on laboratory animals, in particular on homogeneous strains of rodents, these models corresponding as closely as possible to at least one of the respective criteria of isomorphism consisting of mimicking as closely as possible the clinical symptoms of the human disease, homology with the physiopathological mechanisms of this disease and finally therapeutic predictivity in order to determine the processes which appear most appropriate for treating it.

Under these conditions, the study of the sleep disorders caused in the animal under precisely determined conditions of severity and/or of duration, make it possible to study their various aspects separately and to deduce from their consequences the best approach for treating the corresponding human disease, by largely avoiding numerous confusing factors likely to be encountered if the latter is studied directly (complex interactions of the different components of the pathology, uncertain previous duration of the latter, genetic heterogeneity of the patients, their lifestyle and antecedents, effects of previous treatments etc.).

It is generally known that sleep in humans corresponds to a process of great complexity and passes in particular through several successive stages, including a first phase of so-called light, slow sleep, followed by a second phase of so-called deep, slow sleep. In the usual cycle, there is then a final phase, so-called paradoxical sleep, where the individual's eyes are animated by rapid and jerky movements, muscle tone is absent, heart rate and breathing become irregular, with significant variations in arterial pressure.

The use of experimental models produced using carefully selected animals subjected to perfectly quantified stimuli spaced out over time during the sleep cycle according to precisely determined intervention plans, takes this complexity of the cycle into account, allowing an improved approach to these various situations.

It is known moreover that outside the so-called “spontaneous” models, the study of sleep disorders most generally makes use of two distinct techniques.

The first involves functional disturbances produced following a continuous or intermittent interruption, according to predetermined sequences, of the phases of sleep, with examination of the consequences produced on the physiological behaviour of the individual, which, depending on the intensity of the stimulus applied, will result in small or large modifications to locomotor activity.

The second will consist of creating conditions characterizing an acute or chronic situation, which can reproduce the consequences of a continuous or intermittent respiratory disorder equivalent to sleep apnoea syndrome. The latter may in particular classically take the form of repeated pharyngeal collapse resulting in hypoxia and involving an increased respiratory effort to counteract the obstacle thus created in the pharynx and to remove it, resulting in successive micro-awakenings necessary to remove this obstacle and allow a satisfactory re-oxygenation of the respiratory system. The latter phenomenon, during which the supply of oxygen to the lungs is substantially reduced for varying lengths of time, is known as intermittent hypoxia, the effects of this pathology can be particularly serious under certain circumstances and require complex treatments, which are restrictive and expensive.

The solutions currently recommended for implementing these techniques of sleep deprivation or fragmentation on the one hand, and of continuous or intermittent hypoxia on the other hand, consist in the first case of placing inside a cage or a specific device of the kind in particular of an experimentation enclosure containing the animals, means suitable for creating a physical contact with these animals, which is continuous or repetitive, in this case occurring at specific time intervals, in order to permanently prevent them from falling asleep or on the contrary to wake them up periodically after defined phases of sleeping, such that their sleep or their absence of sleep corresponds to the programme envisaged for the study of their behaviour and of the physiological or pathological consequences produced on their cardiovascular, neurological, metabolic or other systems.

Other means intended to create a stimulus on the animal, suitable for preventing it from falling asleep or intended to wake it at the desired time, can of course be similarly envisaged, for example by replacing a physical contact of mechanical or manual origin with a sound, vibratory, or even visual effect.

In the case of hypoxia, the device, in particular the experimentation cage containing the animals, is very often of a design which is completely distinct from that envisaged for producing sleep deprivation or fragmentation, in particular since it comprises no mechanical or equivalent means for waking the animal or preventing it from sleeping. Here, the cage is simply supplied with respiratory air or an appropriate gas, the composition of which can vary on demand, in order to be able to artificially produce a situation of continuous or intermittent hypoxia, obtained by reducing for example the oxygen content of the air, which can pass in particular from 21% in the normal phase corresponding to ambient air to 5% or less in the period of maximal intermittent hypoxia, there also according to a determined programme defining the conditions which prevail most commonly in the case of sleep apnoea or other respiratory disorders in humans, with measurement of the electro-encephalographic activity and of the heart rate in particular.

In both cases, which are implemented separately in the state of the art, the experimentation must at all times be carried out with the utmost respect for the environment of the treated animals, in particular by limiting in the best possible way, the stress factors to which they can be subjected by the operating conditions, the experimentation cages in particular having to allow organized contact between various populations of these animals in order to prevent their isolation and on the other hand to create a socially acceptable environment among them, provide their confinement atmosphere with an appropriate degree of humidity and sound level, ensure that they have easy and unrestricted access to food and water or other drinking liquid, and provide conditions for intervention of the means ensuring sleep deprivation or fragmentation or creation of the other disturbances described above, which are as gentle as possible etc.

The present invention relates to a device of this kind which has the advantage of allowing both experiments based only on sleep deprivation or fragmentation associated or not with a modification of the locomotor activity, and on the production of continuous or intermittent hypoxia, or even on both of these techniques simultaneously, by varying at will the parameters of the experiments carried out in connection with sleep disorders or the wakefulness thus caused, using a single confinement cage for the treated animals, this device being simple to construct, easy to use, providing the best comfort to the animals which are thus subjected to minimal stress in their environment and making it possible overall to collect reliable and easily reproducible data on the behaviour of these animals and the physiological and pathological consequences of the disorders created.

To this end, the device considered is characterized in that it comprises, in combination,
a horizontal circular support plate for laboratory animals subjected to experiments, which can be driven in rotation about a vertical axis,
a revolving outer cylindrical wall, the outside diameter of which is substantially equal to that of the rotary plate, open at the top and the axis of which coincides with that of the plate, this wall delimiting an internal confinement space forming a cage for housing the animals moving freely on the plate,
a fixed intermediate separation partition, extending diametrically inside the cylindrical wall passing through the vertical axis of the plate so as to divide the internal confinement space into two opposite compartments,
a top closing and protective lid, preferably removable, extending inside the outer cylindrical wall, parallel to the circular plate,
and a system for the supply of respiratory gas through the closing lid, for the animals present in the two opposite compartments of the confinement space.

In a first embodiment of the device, the outer cylindrical wall is integral with the support plate and turns with the latter when it is driven in rotation about its vertical axis.

In a variant, the outer cylindrical wall is fixed, optionally integral with the separating partition, the support plate turning with respect to this cylindrical wall with a minimal clearance.

Advantageously, the respiratory gas supply system comprises an end piece which opens, beyond the closing lid, into a diffuser housed in the confinement space, also suitable for equally distributing the flow of gas into the two compartments delimited by the intermediate separating partition.

Evacuation apertures are provided in the cylindrical wall or between the wall and the top closing lid allowing the respiratory gas to escape outside the cage, in order to keep the pressure of this gas in the confinement space substantially constant, while ensuring its constant renewal. An extractor device can be provided in at least one and preferably both compartments for removal of the respiratory gas from the confinement space as it is supplied, after circulation in this space.

Preferably, the closing lid comprises passages for electric wires, cables, catheters or other fine tubes, suitable for connecting the animals present in the two compartments of the confinement space to external measurement and/or monitoring means, in order to take readings, samples, or to record physiological or behavioural data from these animals during experimentation.

As a variant, the animals in the two compartments of the confinement space are provided with wireless sensors, delivering information which is measured and monitored outside the cage, by telemetry.

Moreover, the at least one of the passages through the closing lid is advantageously equipped with a probe for measuring the oxygen content or other component of the respiratory gas, admitted into the confinement space.

According to an additional characteristic of the device considered, the fixed separating partition has a mesh surface or is equipped with holes distributed over its surface in order to ensure communication between the two compartments of the confinement space, allowing the animals respectively present in them to establish physical contact or mutual closeness with each other, suitable for diminishing their feeling of isolation and to this extent reducing the stress caused by their relative isolation in each of these compartments.

Preferably, the fixed separating partition comprises a transverse lower edge, equipped with a succession of slots or indentations, in particular in a saw-tooth pattern or having another segmented profile, creating narrow passages through this partition between the two compartments, in order to allow a thickness of litter or similar, arranged on the support plate and turning with the latter, not to be scraped by the fixed partition, accumulating in contact with the latter, but to be permanently distributed substantially equally between these two compartments, without however allowing the animals kept respectively in the two compartments of the confinement space to pass through.

As a variant, the slots in the lower edge of the separating partition have a rectangular, triangular profile.

Preferably, the support plate incorporates a removable drawer open at the top for receiving this litter, this drawer being suitable for sliding transversally with respect to the plate in order to allow the soiled litter to be removed as needed and replaced with clean litter.

In particular, the support plate can comprise a fixed or mobile grid, arranged with its surface parallel to the top of the plate, which can support and keep the animals in the confinement space during the evacuation and replacement of the litter in the removable drawer.

According to an improvement to the device, the lower edge of the separating partition can comprise means for attaching a separator or similar, extending parallel to the support plate through these slots, the positioning of which is height-adjustable, in order to adjust the free surface of the passages between these slots.

These attachment means can be advantageously constituted by oblong and elongated holes provided in the separator and/or the partition, and cooperating with locking screws in position opposite each other.

As a variant, a removable transversal rod can be arranged through passages between the slots in order to limit their free surface and prevent the animals present in the two compartments from passing through them.

If appropriate, the surface of the support plate can comprise a non-slip coating in order to limit, during the rotation of this plate, the sliding of the animals in contact with the intermediate partition.

According to yet another feature, the device comprises a fixed outer frame, supporting the separating partition and/or the attachment lid.

In a preferred embodiment, the fixed frame comprises a set of vertical columns, preferably distributed regularly around and at a distance from the cylindrical wall, these vertical columns being joined to their base with a horizontal plate extending under the support plate and, at their opposite end, an assembly for support of the closing lid, preferably constituted by interlocked crosspieces.

These crosspieces can be screwed at their ends onto the columns of the frame or, as a variant, comprise internal interrupted circular grooves which can cooperate with projecting catches provided on the columns in order to immobilize them on the fixed frame by engagement of these catches in the grooves in the manner of a bayonet connection.

According to yet another characteristic, the fixed separating partition comprises means for putting into place, in the confinement space, at least one feeding system making it possible to permanently provide the animals present in the two compartments of this space, with the feed and drink required for their needs. Usually this system is constituted by at least one feeder basket with a largely open structure, filled with nutritive granules or similar and by supports for bottles of water or other drink, inverted and comprising a cannula delivering this water on demand by contact of the animals' snouts with its end.

The feeder basket can be directly fixed to the separating partition or to any support close to the latter.

Advantageously, the closing lid comprises, opposite the feeder basket, windows for pouring these nutritive granules into the basket, these windows normally being closed by removable stoppers, which can be withdrawn through the top of the lid.

As a general rule, the support plate is rotated by means of an electric motor, preferably with variable speed and reversible direction of rotation.

According to various embodiment variants, the output shaft of the electric motor directly drives the support plate about its vertical axis, or comprises a control driving pinion in engagement with a driven pinion positioned on this vertical axis or also is in engagement with a circular rack arranged inside or outside on the periphery of this plate.

In a preferred embodiment which eliminates the clearances between the teeth of the pinions and the vibrations which can result from these, the output shaft of the electric motor actuates a lateral return pulley, in the groove of which passes a friction drive belt, housed in an open groove provided externally around the support plate.

In this variant, the motor is preferably carried by a tower with a vertical axis, merged with or offset vis-à-vis the output shaft of the electric motor, this tower being able to pivot slightly about this vertical axis in order to modify the relative position of the return pulley vis-à-vis the groove of the support plate and to adjust on demand the pressure of the drive belt, before locking the tower into position.

Other characteristics of a device for studying sleep disturbances established according to the invention will also become apparent through the following description of an embodiment example, given by way of a non-limitative indication, with reference to the attached drawings in which:

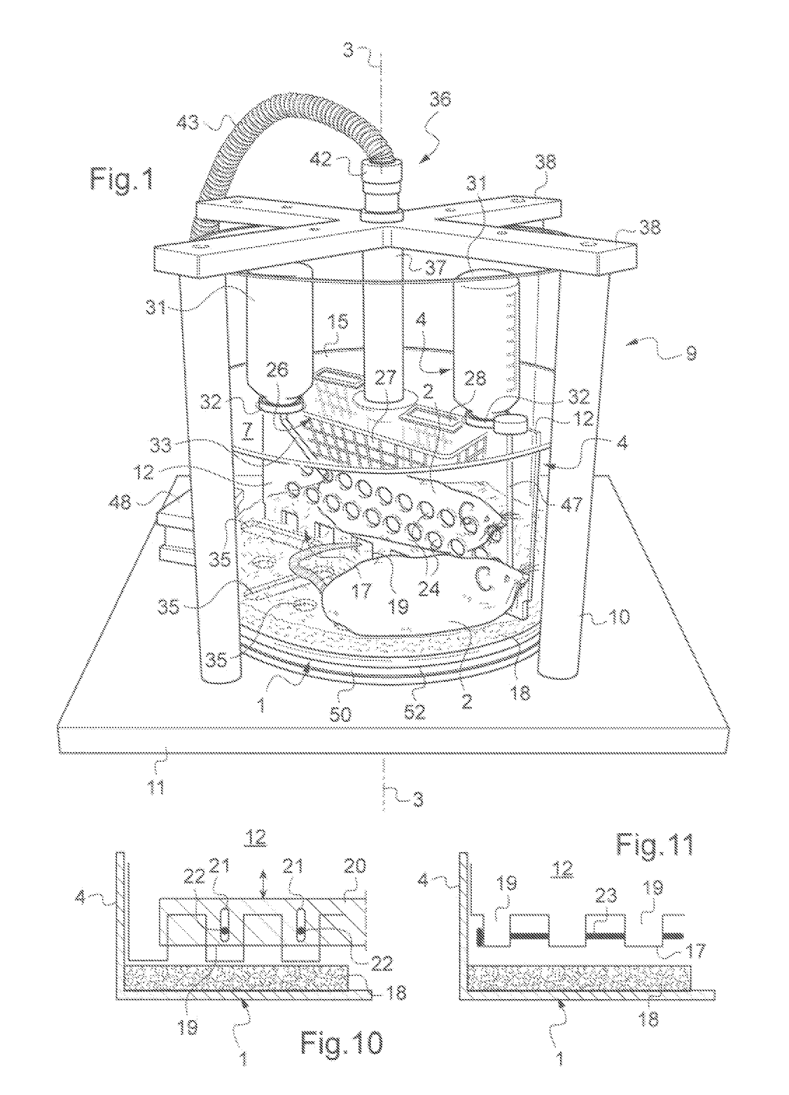

FIG. 1 is an overview, in perspective, of the device considered.

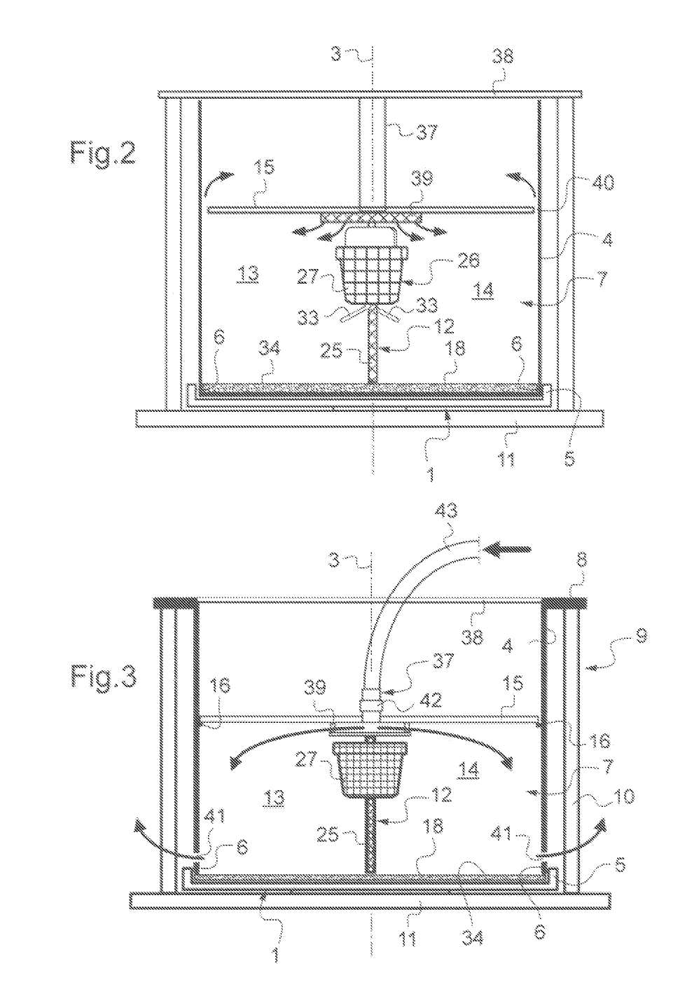

FIGS. 2 and 3 are simplified diagrams of the device viewed in axial section, illustrating more particularly the relative positioning of the rotary plate, outer cylindrical wall, intermediate separating partition and upper closing lid with the respiratory gas supply pipe, according to two embodiment variants.

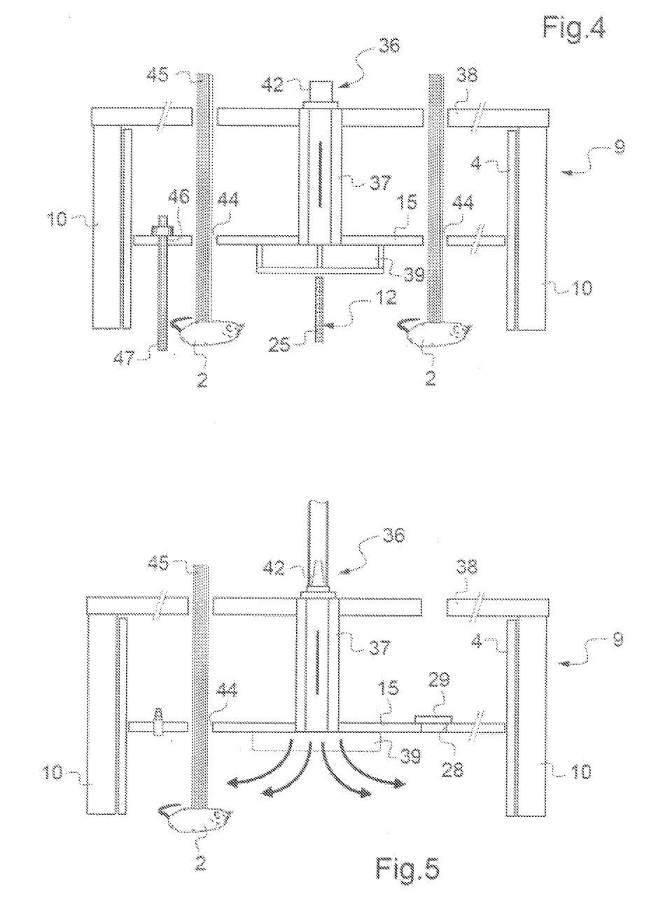

FIGS. 4 and 5 are partial views, also diagrammatic, of the upper part of the device and various pieces of equipment thereof.

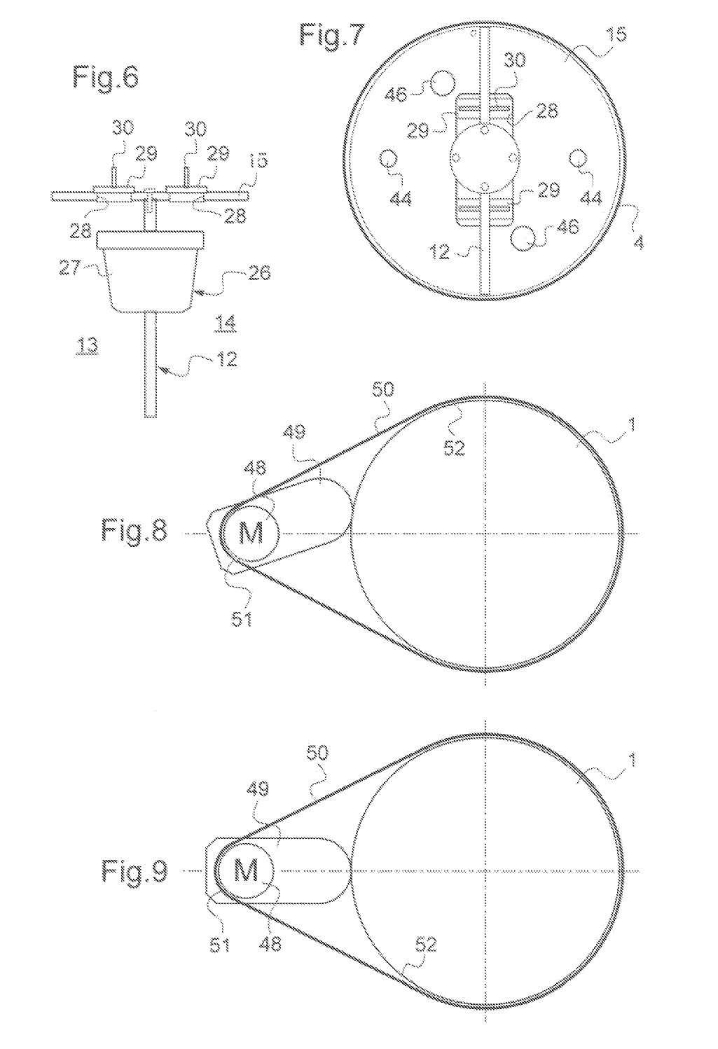

FIGS. 6 and 7 respectively illustrate details of the closing lid in elevation and in partial top view.

FIGS. 8 and 9 are diagrams illustrating an embodiment of the drive means of the rotary plate and of the control electric motor.

FIGS. 10 and 11 illustrate two variants of the intermediate separating partition of the device.

FIG. 1 shows an overview of a preferred embodiment of the device of the invention to which numerous modifications of detail can of course be made without the scope of the latter being exceeded, to the extent that they do not change the general structure of the device and its various functionalities.

The device essentially comprises a lower plate 1, circular in shape, suitable for supporting in the device, laboratory animals 2 to be subjected to experiments, in particular of the rodent genus or similar, in particular in order to study and monitor their behaviour and their reactions in connection with disorders created during their periods of sleep or wakefulness, by causing a continuous or intermittent interruption of the sleep phase in particular and/or by artificially creating, simultaneously or separately, conditions capable of creating a respiratory disorder depending on the nature of the inhaled gas and its composition.

The support plate 1 extends horizontally. It is arranged so as to be able to rotate about a vertical axis 3 passing through its centre, while being driven using motor means which will be explained below and which make it possible in particular to vary the speed of rotation of the plate as well as the direction thereof as desired.

The circular plate 1 is associated with a cylindrical outer wall 4, revolving about the vertical axis 3 about which this plate rotates, this wall 4 being able, in a first form of execution, to be integral at its lower end with the periphery of the plate so as to rotate about the vertical axis with the latter as shown diagrammatically in FIG. 2 where the outer edge of this plate comprises a short vertical turned-up section 5 to which, in this variant, the base 6 of the wall 4 is connected, by seal welding.

Depending on the case, according to variants of simple mechanical construction, wholly equivalent from the point of view of the invention, the wall 4 comprises a base which is applied directly to the plate while being independent of the latter, or the latter directly forms the base of the cylindrical wall.

In other solutions, also equivalent, the cylindrical wall 4 can also be connected to the plate 1 by means of different mutual connections, of the kind of studs borne by the one and penetrating into opposite housings in the other or vice-versa, so that the driving of the plate simultaneously ensures that of the wall.

When the plate 1 and the cylindrical wall 4 rotate together about the vertical axis 3, these two elements, if they are constituted by the same material or by compatible materials, may have been manufactured simultaneously.

Advantageously, the circular plate 1 and the cylindrical wall 4 are produced with rigid and transparent plastic materials, of the “plexiglass” type or equivalent, in particular polycarbonate, so as to give them sufficient mechanical strength and at all times to allow a continuous and optimum view of the animals 2 supported by the plate 1 and contained by the outer wall 4 which thus delimits a space 7 confining these animals, forming a cage.

In the latter, the animals 2 can be housed alone or preferably with others, depending on its appropriately choosen diametric dimensions, and move around relatively freely, the presence of a given number of these animals simultaneously in this space, which can thus be in physical contact with each other, constituting a factor suitable for significantly reducing the stress resulting from their being placed in the cage and the rotating movement of the plate.

In another embodiment variant, illustrated diagrammatically in FIG. 3, the horizontal plate 1 and the outer cylindrical wall 4 are this time independent of each other. In the example more particularly described here, this wall 4 is fixed and arranged so that its base 6 engages freely with a minimal clearance inside the vertical turned-up section 5 of the plate which thus swivels about the axis 3 inside the wall.

In this same variant, the outer wall 4 is connected by a shoulder 8 or other suitable connecting component, to an outer support frame 9, here comprising vertical columns 10, preferably distributed regularly around the axis 3 and connected at their base to a lower horizontal support plate 11 above which the plate 1 rotates; this frame 9 is also provided in the first variant where the outer wall 4 rotates with the plate 1.

The device also comprises, mounted inside the confinement space 7 forming a cage, delimited by the rotary plate 1 and the cylindrical wall 4, an intermediate separating partition 12, passing through the vertical axis 3 and dividing this space into two identical and opposite compartments 13 and 14, capable of separately receiving two groups of animals 2, thus housed respectively on either side of this partition (FIG. 1).

The separating partition 12 is fixed and is consequently independent of the rotary plate 1 and the cylindrical wall 4 in the variant of FIG. 2 where these two elements rotate together about the vertical axis 3. In the variant of FIG. 3, the partition 12 can on the other hand be connected to the cylindrical wall 4 with respect to which the horizontal plate 1 rotates.

The separating partition 12 is joined to an upper lid 15, extending horizontally inside the cylindrical wall 4, which rotates with respect to this lid with a minimal clearance between them (FIG. 2) or, if appropriate, is joined to it (FIG. 3) by an inner connecting flange 16, this upper lid closing the two opposite compartments 13 and 14 of the confinement space 7 from above.

This upper lid 15 is removable, in particular in order to completely free the access to the two compartments 13 and 14 in order to introduce the animals 2 and house them in the latter, and also to allow the latter to be fitted out as made necessary by the experiments to be carried out.

At its lower part, the partition 12 comprises a horizontal edge 17 which extends above the rotary plate 1 with sufficient passage clearance to allow litter 18 or similar absorbent material to cover the surface of the plate with a thickness suitable for providing the animals 2 housed in the compartments 13 and 14 with a suitable level of comfort and moreover for collecting their excreta in a suitable manner over a given period of time, before this soiled litter is removed and replaced, this clearance being defined by construction so that, during the rotation of the plate, this litter is not unduly scraped by the edge 17 of the partition which ensures only that it is equally thick in both compartments.

In particular, as the litter 18 has to be changed and renewed at suitable time intervals, the support plate can incorporate various means making it possible to carry out this replacement simply and efficiently, without, as a result of these operations, causing particular stress to the animals which are housed in the cage, stress which would be strongly prejudicial to the results of the experiments carried out.

Thus, the support plate 1 can for example incorporate a drawer (not shown), open at the top, housed in a groove provided in the thickness of the plate and capable of sliding transversally with respect to the latter to allow easy access to the litter 18 to be changed in order to replace it with new clean litter, before the drawer is put back into position in the plate, under the separating partition 12.

Advantageously, this drawer can be associated with a grid, fixed or preferably mobile (also not shown so as not to overload the drawing) or with a similar open-worked component, arranged parallel to the surface of the plate above the latter and normally embedded in the thickness of the litter, this element, the width of the mesh of which is suited to the size of the animals 2 in the two compartments 13 and 14 of the confinement space 7, being capable of bearing and keeping these animals 2 in this space above the drawer sliding during the removal and replacement of the litter, in particular by slightly raising the grid or the component against the lower edge 17 of the intermediate separating partition 12 of these two compartments.

Advantageously, the lower edge 17 of the partition 12 comprises a succession of slots 19 or similar indentations, with a segmented profile, in a saw-tooth pattern in particular, the shape and in particular the height and/or the depth of which are chosen so as to establish a sufficient communication on either side of the partition, allowing the two groups of animals in the compartments 13 and 14 to have a relationship of sufficient closeness to each other, olfactory in nature and in particular by contact at some points, however without the animals in one group being able to mix with those in the other by passing unduly through the separating partition 12 from one compartment to that opposite to it, on the opposite side of this partition.

Depending on the size of the animals 2 during experimentation, present in the two compartments 13 and 14 of the confinement space 7, the free height of the opening thus arranged in the lower edge 17 of the partition 12 can be modified by adopting a solution two non-limitative variants of which are illustrated by FIGS. 10 and 11.

In FIG. 10, the slots 19 in the partition 12 are partly closed by a transversal separator 20, applied against this partition by being arranged parallel to its lower edge 17, the positioning of the separator being adjustable, for example by providing on the latter oblong openings 21 passed through by screws 22 the heads of which ensure the immobilization of the separator applied against the partition.

In the variant of FIG. 11, the slots 19 are crossed by a transversal rod 23 which prevents the passage of the animals, this rod passing through facing holes provided in the thickness of the partition 12 between the successive slots; the lower edge 17 can comprise several superimposed rows of such holes in order to vary the positioning of the rod 23 in these slots.

The upper lid 15 is preferably made of the same rigid and transparent plastic material as that which forms the outer cylindrical wall 4. The separating partition 12 can also be constituted by this material, so as to allow a simultaneous view of the animals 2 in the two compartments 13 and 14 through this partition. In this case, the partition preferably comprises perforations 24 distributed over its surface (FIG. 1) in order to further improve the relative mutual perception between the animals in the two groups, housed in these compartments, and facilitate the circulation of the respiratory gas on either side of this partition.

As a variant, the separating partition 12 can be formed by a mesh component 25 with reduced mesh size, as shown diagrammatically in FIGS. 2 and 3.

The partition 12 and the lid 15 are moreover equipped with an assembly 26 making it possible to permanently ensure the feeding of the animals 2 present in the two compartments 13 and 14 of the confinement space 7, the nature of the components making up this assembly 26 as described hereafter and the manner in which they are arranged or borne by the partition and the lid 15, being able to be subjected, on a case-by-case basis, depending on the space requirement of these components and their relative positioning above the animals 2 present in these compartments, to numerous constructional variants which themselves have no effect on the invention.

Thus and preferably, this assembly 26 is made up of at least one feeder basket 27, open at the top, thus being capable of being filled whenever necessary with nutritive granules or other similar substances suitable for the controlled feeding of the animals, these products being poured into each basket 27 through a window 28 provided opposite in the surface of the upper closing lid 15 above the compartments 13 and 14, these windows being, outside the basket-filling periods, closed by removable stoppers 29 provided with hand grips for manipulation 30 or similar (FIGS. 6 and 7).

Each feeder basket 27 can be fixed at an adequate height on the separating partition 12 under the lid 15, and arranged, as shown in the example, so as to extend laterally beyond the latter inside each of the two compartments 13 and 14 (FIGS. 2, 3 and 6), making it possible to simultaneously deliver the feed products that it contains to the two groups of animals present in these compartments. To this end this basket 27 has a wide-meshed structure, so that these animals can easily place their snouts at a height through these meshes in order to feed on the desired quantity of food whenever they feel the need, without having to produce an excessive effort in order to satisfy it.

Of course, the device could comprise two or more separate baskets, housed in the one and the other of the two compartments respectively and supplied separately with the products to be delivered, their attachment in the cage being able to be achieved in a different fashion, for example on a support independent of the separating partition 12 or of the lid 15.

The feeding assembly 26 also comprises, arranged opposite each of the two compartments 13 and 14 and borne by the lid 15, water bottles 31 (FIG. 1), advantageously made of plastic material, each cooperating with a pierced support 32 on the top of this lid and comprising a cannula 33 which penetrates into the confinement space 7, this preferably rigid, curved or straight cannula, the free end of which is brought to the appropriate height in the corresponding compartment when the bottle is fixed to its support, making it possible to deliver the water from the bottle to the animals, by simple contact with their snouts and licking of this end, the thirsty animal having only to raise itself up slightly to reach the cannula.

Advantageously, the surface of the rotary plate 1 directed upwards and on which the litter 18 rests can comprise a non-slip surface 34 (FIGS. 2 and 3) in order to reinforce the effect of the waking stimulus and/or to force the animal to move during the rotation of the plate.

According to the invention, the upper closing lid 15 is equipped with a supply system 36, arranged so as to be able to deliver into the confinement space 7 a suitable flow of a respiratory gas, as a general rule air, the pressure and temperature characteristics, and especially composition of which can vary according to the experiments to be carried out, this air being delivered in the pipe from a suitable source (not shown) outside the device, the specific characteristics of which have no effect on the invention so there is no need to describe it here more in detail.

As shown in FIG. 1, the system 36 comprises an end piece 37 ensuring the connection at one of its ends with the lid 15. The latter is joined to the support frame 9, in particular by means of a connection assembly formed by interlocked crosspieces 38, borne by the vertical columns 10 of this frame and either screwed onto the latter as shown in FIG. 1, or connected by an assembly with catches and grooves (not shown so as not to overload the drawing), producing a bayonet connection, making it possible to detach the removable lid 15 from the frame 9 more simply and more rapidly, in order to allow access to the two compartments 13 and 14.

The end piece 37 can be joined to the connecting crosspieces 38 (FIGS. 1, 2, 4 and 5) or directly linked to the source which delivers the flow of respiratory gas to the compartments 13 and 14 (FIG. 3).

At its end joined to the closing lid 15, the end piece 37 opens into a diffuser 39 which makes it possible to regularly deliver the respiratory gas at a constant or optionally variable flow rate, into the two compartments 13 and 14 of the confinement space 7 (FIGS. 4 and 5). The gas exits either through the clearance 40 left free between the closing lid 15 and the outer cylindrical wall 4 when the latter rotates with the plate 1 (FIG. 2), or through openings 41 arranged in this wall, in particular when the latter is fixed with respect to the plate 1 (FIG. 3).

A forced extraction device (not shown), of a type known per se and which therefore has no more direct relevance to the invention, can be mounted under the lid 15 in at least one of the compartments 13 or 14, in order to improve the removal of the respiratory gas from the cage and thus facilitate the conditions under which intermittent hypoxia is produced.

At its opposite end, the end piece 37 of the system 36 is joined by a connector 42 to flexible piping 43 which is connected to the source of respiratory gas.

The closing lid 15 also comprises free passages 44 (FIGS. 4 and 5) for electric wires, cables, catheters or various fine tubes, colletively designated by the reference number 45, which are provided in order to ensure the necessary connections between measurement means (not shown and standard per se) and the animals 2 subjected to experiments, present in the compartments 13 and 14, in order to take all the desired measurements, readings, recordings and/or samples from these animals at the points in time determined by the programme carried out.

These passages 44 are preferably arranged close to the central part of the separating partition 12, in the two compartments 13 and 14, in order to allow the best possible freedom of movement of the animals 2 in the latter, as they move at will, independently or at the same time as the plate 1 rotates.

It should be noted that these wires or other measurement or sampling components 45 are used especially if each of the two compartments 13 and 14 contains only a single animal, as these wires are likely to become entangled rapidly if several animals are housed together due to their obviously mutually uncoordinated movements, quite apart from the fact that the wires with which one animal is equipped can be more or less easily gnawed by its neighbours.

In this case, the behaviour and the physiological constants of the animals 2 can in known manner be monitored and measured outside the cage by telemetry from sensors or emitters implanted in each animal

An additional passage 46 is advantageously reserved in the lid 15 in at least one of the compartments 13 and 14, for fitting a measuring probe 47, for oxygen for example (FIG. 4), in particular during the phases of hypoxia induced, in order to continuously provide the content at any moment of this component or of another in the respiratory gas delivered to the animals 2 during experimentation.

The horizontal plate 1 is driven in rotation about its vertical axis 3 by any suitable means, in particular by a reversible electric motor 48, shown diagrammatically in FIGS. 8 and 9.

In a preferred embodiment, this motor 48 is supported by a tower 49, which can swivel slightly about a vertical axis (not shown), in order to occupy variable positions between those illustrated respectively in these Figures, where the tower forms an angle with the vertical plane containing the axes of this tower and the axis of rotation of the plate 1 on the one hand, or extends in the direction of this plane on the other hand.

In this non-limitative example, the electric motor 48 the output shaft of which is merged with the axis about which the tower swivels, drives a friction belt 50 which passes in a return pulley 51 positioned on the shaft of the motor on the one hand, in a peripheral groove 52 arranged on the outer section of the rotary plate 1 and situated in the same horizontal plane as the pulley 51 on the other hand, the relative swivelling of the tower 49 bearing the motor 48 modifying the tension of the belt 50 by acting on the driving speed of plate 1.

As a variant, it would also be possible to envisage to equipping the output shaft of the motor with a control pinion the teeth of which would be in engagement with a rack borne by the plate. It would also be possible to envisage a drive pinion fixed onto the output shaft of the motor in engagement with a driven pinion locked on the axis of the rotary plate, these pinion solutions being able however to introduce assembly play and vibrations which are eliminated in the above variant, with a friction belt.

The device thus produced is utilized as follows in order to create controlled sleep disturbances in the animals during experimentation and measure the physiological effects of the latter, in particular the electroencephalographic, cardiac, neurological, metabolic or other effects, according to precisely defined programmes with constraints imposed on these animals which are all the more limited as the device is designed to reduce as far as possible the nature and severity of the stresses necessary for the creation of these disturbances.

As already disclosed, the device makes it possible to produce on the animals tested, in particular on homogeneous strains of the latter and preferably on rodents, the biological and psychological characteristics of which are highly reproducible from one individual to another, similar in size, weight and age, disturbances resulting in either a constant interruption to their sleep, or a fragmentation of the latter with a specific frequency and duration, by an intervention with a purely mechanical effect, reproduced at chosen time intervals, which may optionally be accompanied by an increase in locomotor activity, or also a phase of continuous or intermittent hypoxia, the latter creating the characteristics of apnoea syndrome during a given cycle, this first phase being followed by a period of re-oxygenation, making it possible for the animal to re-establish its breathing, this process making it possible to model most closely conditions most like those which prevail in the human pathology of this syndrome.

The device makes it possible in particular, using the same apparatus, to create the corresponding sleep disorders, or even to combine their effects and to measure the resulting consequences.

With regard to the means capable of producing interruption or fragmentation of sleep, it will be immediately understood that by controlling the speed, or even the direction and frequency of the movements of rotation of the rotary plate, there is created for the animals which are present in each of the two compartments of the confinement space and which are resting therein on their litter, a suitable dragging effect which is interrupted upon contact with the fixed separating partition inside the wall which surrounds the plate and rotates or does not rotate with the latter.

This contact which the animal cannot resist, or at the very least which it cannot prevent, necessarily causes a disturbance which, if it is in the sleep phase, will lead to its waking up by forcing it to want to move away from the partition against which it is systematically brought if the plate continues to rotate.

In the wakefulness phase, this same property makes it possible to increase its locomotor activity in a determined manner.

By using an automatic control and regulation system, the characteristics of which are per se standard and have no significance for the invention, to adjust the speed of the rotation of the plate, and therefore the repetition of the animal's contacts with the fixed partition according to its own reactions to avoid it and not be subjected to the effects brought about by this rotation, or even to adjust the direction of this rotation in order to reverse the situation at given points in time and at chosen time intervals, it is thus possible either to fragment the sleep of these animals, or to systematically interrupt it, the phases of falling asleep being immediately interrupted by a new contact with the partition.

It should be noted that the lower edge of this partition can comprise parts or components projecting towards the inside of the compartments in order to prevent the animals from grouping together preferentially in the central part of the partition, close to its axis of rotation where the relative movements of the plate are most reduced and where the contacts with this wall have least effect.

The animals in each of the two compartments are equipped with the remote measurement means which are necessary for taking the desired readings and recordings. These results are of course continuously collected throughout the experimentation carried out, by means of appropriate wire connections or by telemetry as disclosed above.

The separate or simultaneous production of the conditions characterizing sleep apnoea syndrome can also be achieved in the same apparatus, this time by adjusting the composition of the respiratory gas, in practice of the air, introduced into the the animals' confinement space, this gas, which circulates continuously, being introduced through the supply pipe and evacuated through the apertures or passages arranged in the cylindrical wall which delimits this space above the rotary plate, if appropriate by the additional extraction device.

By controlled modification of the oxygen content of this respiratory gas, in particular by reducing this content within the limits stipulated in the preamble to the present description, a situation is artificially created during a predetermined time cycle (for example between 30 and 60 seconds depending on the nature of the rodents studied), where the animal is subjected to a phase of hypoxia, the source of a more or less pronounced respiratory disorder giving rise to fluctuations in the subject's cerebral activity, arterial pressure and heart rate, the effects of which are monitored and measured as previously, by means of the specialized monitoring equipment with which the animals are equipped during experimentation.

External means which are also standard, ensure the continuous monitoring of the composition of the respiratory gas, in particular the proportions of oxygen, nitrogen or carbon dioxide in the latter, its flow rate, its pressure and its temperature, making it possible at any moment to vary the experimental conditions and to measure and record their effects on the treated animals.

Thus a device of very simple design is produced, which is easy to manufacture for a relatively moderate cost, very flexible in use and in particular making it possible to carry out multiple experiments without having to modify the apparatus, but on the other hand by allowing the utilization with the latter of a very wide variety of different parameters under optimal conditions imposing only a few behavioural and environmental constraints on the animals during experimentation.

Of course, it is self-evident that the invention is not limited to the embodiment example more especially described and represented with reference to the attached drawings; on the contrary it encompasses all the variants within the scope of the claims hereafter.

1-30. (canceled)

31. Device for the study of the sleep disturbances in laboratory animals, characterized in that it comprises, in combination,
a horizontal circular support plate (1) for animals (2), which can be driven in rotation about a vertical axis (3),
a revolving outer cylindrical wall (4), the outside diameter of which is substantially equal to that of the rotary plate (1), open at the top and the axis of which coincides with that of the plate, this wall delimiting an internal confinement space (7) forming a cage for housing the animals moving freely on the plate,
a fixed intermediate separation partition (12), extending diametrically inside the cylindrical wall (4) passing through the vertical axis (3) of the plate (1) so as to divide the internal confinement space into two opposite compartments (13, 14),
an upper closing and protective lid (15), preferably removable, extending inside the outer cylindrical wall (4), parallel to the circular plate (1),
and a system (36) for the supply of a respiratory gas through the closing lid (15), for the animals present in the two opposite compartments (13, 14) of the confinement space (7).

32. The device according to claim 31, characterized in that the outer cylindrical wall (4) is integral with the support plate (1) and rotates with the latter when it is driven in rotation about its vertical axis (3).

33. The device according to claim 31, characterized in that the outer cylindrical wall (4) is fixed, optionally integral with the intermediate separating partition (12), the support plate (1) rotating with respect to this cylindrical wall with a minimal clearance.

34. The device according to claim 31, characterized in that the respiratory gas supply system (36) comprises an end piece (37) which opens, beyond the closing lid (15), into a diffuser (39) housed in the confinement space (7), suitable for also equally distributing the flow of gas into the two compartments (13, 14) delimited by the intermediate separating partition (12).

35. The device according to claim 31, characterized in that evacuation apertures (40, 41) are provided between the outer cylindrical wall (4) and the upper closing lid (15) or through this wall allowing the respiratory gas to escape to the outside.

36. The device according to claim 31, characterized in that it comprises an extractor provided in at least one and preferably both compartments (13, 14) for removal of the respiratory gas from the confinement space (7) as it is supplied, after circulation in this space.

37. The device according to claim 31, characterized in that the upper closing lid (15) comprises passages (44, 46) for electric wires, cables, catheters or other tubes (45, 47), suitable for connecting the animals (2) present in the two compartments (13, 14) of the confinement space (7) to external measurement and/or monitoring means.

38. The device according to claim 31, characterized in that the animals (2) in the two compartments (13, 14) of the confinement space (7) are equipped with wireless sensors, delivering informations which are measured and monitored outside the cage, by telemetry.

39. The device according to claim 37, characterized in that the at least one (46) of the passages in the upper lid (15) is equipped with a probe (47) for measuring the oxygen content or other component of the respiratory gas, admitted into the confinement space (7).

40. The device according to claim 31, characterized in that the fixed separating partition (12) has a mesh surface (25) or is equipped with holes (24) distributed over its surface in order to ensure a communication between the two compartments (13, 14) of the confinement space (7).

41. The device according to claim 31, characterized in that the separating partition (12) comprises a transverse lower edge (17), equipped with a succession of slots or indentations (19) in a saw-tooth pattern or other segmented profile, creating narrow passages for communication through this partition between the two compartments (13, 14), in order to allow a thickness of litter (18) or similar, arranged on the support plate (1) and rotating with the latter, not to be scraped by the fixed partition (12).

42. The device according to claim 41, characterized in that the slots (19) in the lower edge (17) of the separating partition (12) have a rectangular or triangular profile.

43. The device according to claim 41, characterized in that the support plate (1) incorporates a removable drawer open at the top for receiving the litter (18), this drawer being suitable for sliding transversally with respect to the plate in order to allow the soiled litter to be removed and replaced with clean litter.

44. The device according to claim 43, characterized in that the support plate (1) comprises a fixed or mobile grid, arranged with its surface parallel to the top of the plate, which can support and keep the animals (2) in the confinement space (7) during the removal and replacement of the litter (18) in the removable drawer.

45. The device according to claim 41, characterized in that the lower edge (17) of the intermediate partition (12) comprises means for attaching a separator or similar (20), extending parallel to the support plate (1) through slots (19), and the positioning of which is height-adjustable, in order to adjust the free surface of the passages between these slots.

46. The device according to claim 45, characterized in that the attachment means are constituted by oblong and elongated holes (21), provided in the separator (20) and/or the partition (12), and cooperating with locking screws (22) in position opposite each other.

47. The device according to claim 45, characterized in that a removable transversal rod (23) is arranged through passages between the slots.

48. The device according to claim 31, characterized in that the surface of the rotary plate (1) comprises a non-slip coating.

49. The device according to claim 31, characterized in that the device comprises a fixed outer frame (9), supporting the intermediate partition (12) and/or the attachment lid (15).

50. The device according to claim 49, characterized in that the fixed frame (9) comprises a set of vertical columns (10), preferably distributed regularly around and at a distance from the cylindrical wall (4), these columns being joined at their base to a horizontal plate (11) extending under the support plate (1) and, at their opposite end, to an assembly for support of the closing lid (15), preferably constituted by interlocked crosspieces (38).

51. The device according to claim 50, characterized in that the crosspieces (38) are screwed at their ends onto the columns (10) of the frame (9).

52. The device according to claim 50, characterized in that the crosspieces (38) comprise internal interrupted circular grooves which can cooperate with projecting catches provided on the columns (10) in order to immobilize them on the fixed frame by engagement of these catches in the grooves in the manner of a bayonet connection.

53. The device according to claim 31, characterized in that the separating partition (12) comprises means for putting into place, in the confinement space (7), at least one feeding system (26) making it possible to continuously provide the animals (2) present in the two compartments (13, 14) with the food and drink required for their needs.

54. The device according to claim 53, characterized in that the feeding assembly (26) is constituted by at least one feeder basket (27) with a largely open structure, filled with nutritive granules or similar and by supports (32) for bottles of water (31) or other drink, inverted and comprising a drip cannula (33), delivering this water on demand by contact of the animal's snout with its end.

55. The device according to claim 54, characterized in that the feeder basket (27) is directly fixed to the intermediate partition (12) or to a support close to the latter.

56. The device according to claim 54, characterized in that the closing lid (15) comprises, opposite the feeder basket (27), windows (28) for pouring the nutritive granules into the basket, these windows normally being closed by removable stoppers (29), which can be withdrawn through the top of the lid.

57. The device according to claim 31, characterized in that the support plate (1) is rotated by means of an electric motor (48), preferably with variable speed and reversible direction of rotation.

58. The device according to claim 57, characterized in that the output shaft of the electric motor (48) directly drives the support plate (1) about its vertical axis (3), or comprises a control drive pinion in engagement with a driven pinion positioned on this vertical axis or also is in engagement with a circular rack arranged inside or outside on the periphery of this plate.

59. The device according to claim 58, characterized in that the output shaft of the motor (48) actuates a lateral return pulley (51) in the groove of which passes a friction drive belt (50), housed in an open groove (52) provided externally around the support plate (1).

60. The device according to claim 59, characterized in that the electric motor (48) is supported by a tower (49) with a vertical axis merged or offset vis-à-vis the output shaft of the motor, this tower being able to swivel slightly about this vertical axis in order to modify the relative position of the return pulley (51) vis-à-vis the groove (52) in the support plate (1) and adjust on demand the tension of the drive belt (50), before locking the tower (49) into position.
